(19) United States
(12) Patent Application Publication
(10) Pub. No.: US 2007/0227832 A1
(43) Pub. Date: Oct. 4, 2007

(54) Elevator roping arrangement

(76) Inventors: Esko Aulanko, Kerava (FI); Jorma Mustalahti, Hyvinkaa (FI)

Correspondence Address: HARNESS, DICKEY & PIERCE, P.L.C., P.O. BOX 8910, RESTON, VA, 20195, US

(21) Appl. No.: 11/785,657

(22) Filed: Apr. 19, 2007

Related U.S. Application Data
(63) Continuation of application No. PCT/FI05/00439, filed on Oct. 11, 2005.

(30) Foreign Application Priority Data
Nov. 16, 2004 (FI) 20041473

(51) Int. Cl. B66B 7/02

(52) U.S. Cl. 187/406

(57) ABSTRACT

The invention relates to an elevator roping system in an elevator provided with a hoisting machine (6) and hoisting ropes (12), in which elevator the hoisting ropes (12) move the elevator car (1) along guide rails (2). The hoisting ropes (12) are disposed to pass from the hoisting machine (6) to at least one diverting pulley (18/18a) on the elevator car (1), after passing around which the hoisting ropes (12) are disposed to pass via at least two diverting pulleys (19/19a and 20/20a) in the upper end of the elevator shaft to a second diverting pulley (21/21a) on the elevator car, after passing around which the hoisting ropes (12) are lead to the next destination.

This application is a continuation of PCT/FI2005/000439 filed on Oct. 11, 2005, which is an international application claiming priority from FI 20041473 filed Nov. 16, 2004, the entire contents of which are hereby incorporated by reference.

The present invention relates to an elevator roping arrangement as defined in the preamble of claim 1.

The hoisting ropes of elevators have been made increasingly thinner and stronger in structure, thereby also making it possible to reduce the diameters of traction sheaves and diverting pulleys. One result of this is that it has been possible to implement even greater suspension ratios, for example 3:1 . . . 7:1, and even higher than that. A high suspension ratio correspondingly means that numerous diverting pulleys are needed as an aid to the suspension, and optimizing their placement has been difficult in many solutions. One problem when using a 4:1 suspension, for example, has been passing the hoisting ropes under the elevator car by means of diverting pulleys situated below the elevator car. This solution increases the space below the elevator car, in which case it is difficult to make it possible to drive to the lowest floor in low shafts.

Likewise the so-called rucksack type of suspension used in conventional elevators supported by the front wall of the elevator shaft is problematic because of the great guide rail forces caused by the eccentric suspension. This drawback has limited the operating range of prior-art elevators supported by the front wall to small and essentially slow elevators and only to low-rise buildings.

The object of the elevator roping arrangement of the present invention is to eliminate the above-mentioned drawbacks and to make possible a reliable, simple and easily positionable elevator roping arrangement, especially for elevators without machine room, with a suspension in which the guide rail forces can easily be controlled. A further aim is to achieve a 4:1 elevator suspension, in which the hoisting ropes do not need to pass under the elevator car, thereby making possible a small elevator car in terms of the space required below it. The arrangement of the invention is characterized by what is disclosed in the characterization part of claim 1. Likewise, other embodiments of the invention are characterized by what is disclosed in the other claims.

Some inventive embodiments are also discussed in the descriptive section of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. The features of the various embodiments can be applied within the framework of the basic inventive concept in conjunction with other embodiments.

One advantage of the solution according to the invention is an essentially simple, compact and concentric suspension, as a result of which the guide rail forces are small. Consequently, with the structure of the invention it is possible to reliably and cheaply implement elevators supported by the front wall of the elevator shaft that are larger, more efficient and can travel higher. Another advantage is that the elevator of the invention can more easily be positioned for example on the exterior wall of a building, on the wall of a lobby inside a large building or on the wall of a courtyard. A further advantage is that the space required below the elevator car is small, thus the elevator car can travel close to the bottom of the elevator shaft. This is very advantageous and useful, especially in old buildings when modernizing old elevators. Another advantage also is that installation work is easier and one diverting pulley that until now has been required in prior-art 4:1 suspension can be dispensed with. An advantage of the support element used in the upper part of the shaft is also that the support element can be constructed to protect the hoisting ropes from dirt in the upper end of the elevator shaft. The horizontal section of the hoisting ropes can be made to pass for example wholly or partially inside the support element, in which case dirt cannot attach to them, which could damage the surface of thin hoisting ropes or could cause the rope to jump out of the groove of a diverting pulley with a small diameter.

In the following, the invention will be described in detail by the aid of a few examples of its embodiments with reference to the attached drawings, wherein

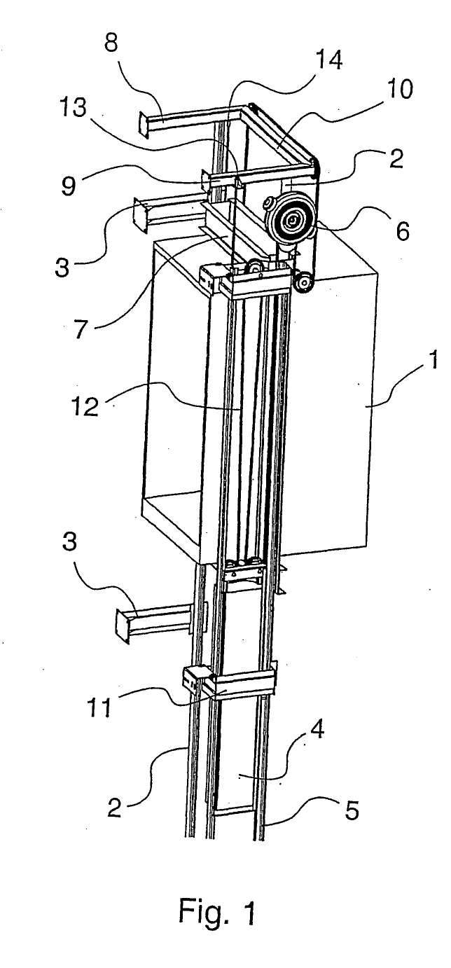

FIG. 1 presents a simplified illustration of one elevator solution applicable to the invention, viewed obliquely from the front and from above,

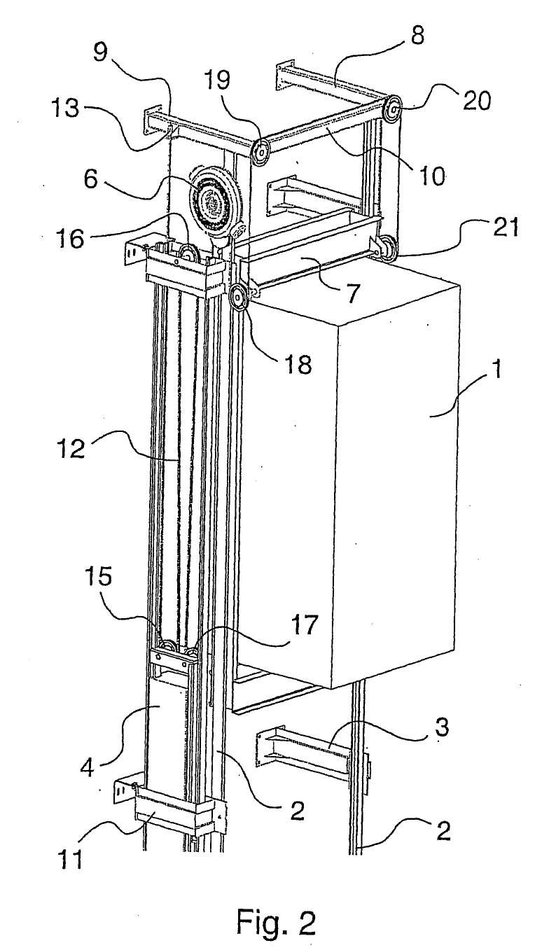

FIG. 2 presents a simplified illustration of one elevator solution according to FIG. 1, viewed obliquely from the rear and from above,

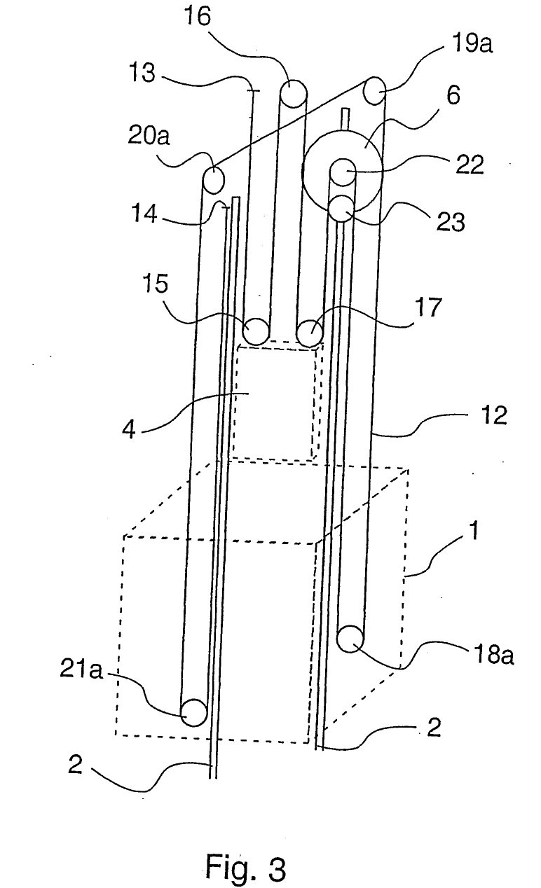

FIG. 3 presents a simplified and diagrammatic illustration of another elevator solution applicable to the invention, viewed obliquely from the side and from above, and

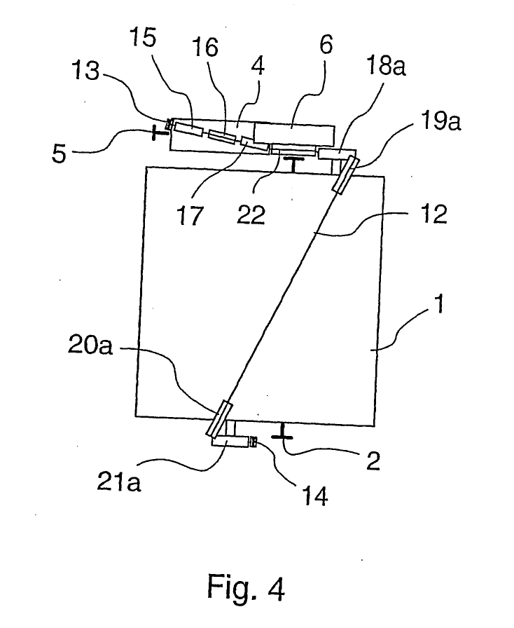

FIG. 4 presents a simplified top view of the elevator solution presented in FIG. 3.

FIG. 1 presents a general illustration of one traction sheave elevator with counterweight applicable to the invention, wherein the rope arrangement of the invention is presented with an elevator car 1 that is equipped with a car sling 7 being in its upper position. The figure is not drawn to scale nor for example with the correct height proportion, so that the position of the counterweight 4 in relation to the position of the elevator car 1 is not necessarily correct. The elevator is preferably an elevator without machine room, in which the drive machine 6 is situated in the elevator shaft. The elevator presented in FIG. 1 is a traction sheave elevator with machine above and with a counterweight 4, in which the elevator car 1 moves on its path along guide rails 2. The hoisting ropes consist of a number of juxtaposed hoisting ropes 12, which are essentially strong and thin in diameter. In addition, the diverting pulleys used and the traction sheave are essentially small in diameter, thus the preferably gearless drive machine 6 is essentially small in size and light.

In the roping arrangement presented in FIGS. 1 and 2 the elevator is supported via the guide rails 2 by the front wall of the elevator shaft or e.g. in a structure without shaft by the exterior wall of the building or similar on the side of the elevator car 1 containing the door opening. For the sake of clarity, only support by the front wall of the elevator shaft will be described below. The guide rails 2 of the elevator car 1 are supported by the front wall of the shaft by means of guide rail fixings 3 and 11, a sufficient amount of said guide rail fixings being a vertical distance from each other for the full height of the shaft. The guide rail fixing 3 is intended to fasten only the guide rail 2 of the elevator car, while both the guide rails 5 of the counterweight 4 and the second guide rail 2 of the elevator car are fastened with a suitably different guide rail fixing 11.

The upper part of the shaft contains an arrangement for fixing and supporting the elevator machine and some of the diverting pulleys used in the roping arrangement. This fixing and support arrangement is preferably fixed to the top end of the guide rails 2 of the elevator car and comprises e.g. substantially rigid and horizontal support beams 8 and 9, and a substantially rigid support element 10. The support beams 8 and 9 are each fixed to the top end of their own guide rail 2, such that the first end of support beam 8, 9 extends to the front wall of the shaft on the first side of guide rail 2, to which the aforesaid first end is fixed by means of e.g. a bolted joint. Correspondingly, the second end of support beam 8, 9 extends in the horizontal direction for at least some distance to the other side of guide rail 2, which is necessary to achieve essentially concentric suspension.

The drive machine 6 of the elevator is fixed to the top end of the second guide rail 2 of the elevator car preferably on the same side of the elevator car as the counterweight 4 traveling on its guide rails 5.

The fixing and support arrangement preferably consists of a frame, which is fixed at one end to the front wall of the elevator shaft and supported near the other side to the guide rails 2 of the elevator car. The support beams 8 and 9, which are essentially the same length as each other, form the edges of the frame in the depth directions of the elevator car and the horizontal and beam-like support element 10 connecting the support beams 8, 9 forms the rear edge of the frame. The support element 10 is fixed to the outermost ends of the support beams 8, 9 and at the same time is supported between the top ends of the guide rails 2. Additionally, at least the diverting pulleys 19 and 20 are preferably fixed to the support element 10 at a horizontal distance from the front wall of the elevator shaft that leaves the horizontal plane between the guide rails 2 of the elevator car between the diverting pulleys 19 and 20 and the front wall of the elevator shaft. In this way the support element 10 is fitted to receive the horizontal component caused by rope forces, while the vertical component is essentially supported by the guide rails 2. Because of the support element 10, the fixing and supporting arrangement is very robust and it is possible to direct the rope forces along the optimal route.

The support element 10 also protects the horizontal section of the ropes from becoming dirty e.g. as a structure of U-profile beam, of which one flange is situated above the horizontal section of the ropes.

FIG. 3 presents a suspension solution corresponding to FIGS. 1 and 2, in which the fixing and support system in the upper part of the shaft may deviate from what has been described above. In addition the diverting pulleys 18a and 21a on the elevator car are disposed on the side walls of the elevator car without a car sling 7. The actual passage of the ropes over the diverting pulleys and the traction sheave fully corresponds to the solution according to FIGS. 1 and 2. The suspension solution according to FIG. 3 is described in more detail in conjunction with FIG. 4.

The passage of the elevator hoisting ropes in FIGS. 1, 2 and 3 is as follows: One end of the hoisting ropes 12 is fastened to the anchored fixing point 13 in the upper part of the shaft, from which fixing point 13 the ropes descend to the diverting pulley 15 fitted into position on the counterweight 4, after having passed under which the ropes continue upwards to the diverting pulley 16, which is fitted into position in the upper part of the elevator shaft. After passing around the top of the diverting pulley 16 the rope returns downwards to the diverting pulley 17 fitted into position on the counterweight 4, and after passing around the bottom of the diverting pulley 17 the hoisting ropes continue upwards to the traction sheave 22 of the hoisting machine 6 fitted into position in the upper part of the elevator shaft, touching the diverting pulley 23 that is preferably positioned in the proximity of the hoisting machine 6 and/or in contact with the bottom part of the traction sheave 22.

Between the diverting pulley 23 and the hoisting machine 22 is DW (Double Wrap) roping as presented in the figure, in which roping the hoisting rope 12 passes upwards touching the diverting pulley 23 to the traction sheave 22 and having passed around the traction sheave 22 returns to the diverting pulley 23, and after passing around the diverting pulley 23 the hoisting rope returns back to the traction sheave 22. Since the diverting pulley 23 is essentially the same size as the diverting pulley 22 in the Double Wrap roping, the diverting pulley 23 can also act as a damper pulley. In such a case the ropes going from the traction sheave 22 to the elevator car 1 travel via the rope grooves of the diverting pulley 23 and bending of the rope caused by the diverting pulley is very minimal. It could be said that the ropes from the traction sheave 22 going to and coming from the elevator car only “touch” the diverting pulley 23. This kind of “touching” serves as a solution for damping vibration of the outbound ropes and is also applicable in other roping solutions.

Other examples of roping solutions include Single Wrap (SW) roping, in which the diverting pulley is substantially the same size as the traction sheave of the drive machine, and in which use of a diverting pulley is applied as the “touching pulley” described above. In the SW roping of the example the ropes pass around the traction sheave only once, in which case the contact angle between the rope and the traction sheave is approximately 180°. In this case the diverting pulley is used only as an aid for the “touching” of the rope in the manner described above, so that the diverting pulley functions as a rope guide and as a damping pulley for damping vibrations.

The ropes continue their passage from the traction sheave 22 downwards touching the diverting pulley 23 to the diverting pulley 18/18a, which is fitted into position preferably on the elevator car 1; either on the car sling 7, as is diverting pulley 18, or on the first side wall of the elevator car, as is diverting pulley 18a. After passing around the bottom of the diverting pulley 18/18a, the ropes 12 continue upwards to the diverting pulley 19/19a fitted into position in the upper part of the elevator shaft, and after passing around the top of diverting pulley 19/19a the ropes continue in a substantially horizontal direction to the other diverting pulley 20/20a fitted into position in the upper part of the elevator shaft, said diverting pulley 20/20a being at essentially the same height as the diverting pulley 19/19a, but substantially symmetrically on the other side of the elevator car as viewed from above.

After passing around the top of the diverting pulley 20/20a the ropes continue their passage downwards to the diverting pulley 21/21a, which is preferably fitted into position on the elevator car 1; either on the car sling as is diverting pulley 21, or to the second side wall of the elevator car, as is diverting pulley 21a. After passing around the bottom of the diverting pulley 21/21a the ropes 12 continue upwards to the anchored fixing point 14 in the upper part of the elevator shaft, to which the other end of the elevator ropes 12 is fastened.

FIG. 4 presents a top view of the roping arrangement presented in FIG. 3. The biggest difference to the roping arrangement according to FIGS. 1 and 2 is that the diverting pulleys 18a and 21a as well as 19a and 20a are not situated as far away from the front wall of the elevator shaft as each other, rather the criterion has been equidistant positioning in relation to the guide rail line of the guide rails 2 of the elevator car 1 as viewed from the top. Likewise, the elevator itself is not necessarily supported by the front wall of the elevator shaft. Instead in the solution according to FIGS. 3 and 4 it is possible to use a support element receiving the horizontal component of the rope forces that corresponds to the support element 10, which if viewed from above would be in a diagonal position with respect to the guide rail line.

It is obvious to the person skilled in the art that different embodiments of the invention are not limited to the example described above, but that they may be varied within the scope of the claims presented below. Thus, for instance, the hoist machine 6 and the traction sheave 22 of the elevator and/or the diverting pulleys 16, 19/19a and 20/20a situated in the upper part of the elevator shaft can be fixed into position on the frame structure formed by the guide rails 2 or on the beam structure situated in the upper part of the elevator shaft or individually onto the elevator shaft or to some other fixing arrangement suited for the purpose. Likewise the diverting pulleys 18/18a and 21/21a on the elevator car 1 can be fixed into position on the frame structure of the elevator car 1 or on a beam structure or beam structures on the elevator car or individually on the elevator car or on some other fixing arrangement suited for the purpose.

It is further obvious to the person skilled in the art that although, for example, there is a counterweight in the suspension described, the invention or preferred embodiments of it can just as well be used in traction sheave elevators without counterweight, as well as with other suspension ratios and in other types of suspensions than that described in the example.

It is also obvious to the person skilled in the art that the use of the diverting pullet 23 described above is not significant with respect to the invention, so that the aforementioned diverting pulley may also be dispensed with.

1. Elevator roping arrangement in an elevator provided with a hoisting machine and hoisting ropes, in which elevator the hoisting ropes move the elevator car along guide rails and the hoisting ropes are disposed to pass from the drive machine to at least one diverting pulley on the elevator car, after passing around which the hoisting ropes are disposed to pass via at least two diverting pulleys in the upper part of the elevator shaft to the second diverting pulley on the elevator car, after passing around which the hoisting ropes are lead to the next destination, wherein-there is a fixing and support arrangement at the top end of the guide rails of the elevator car, said arrangement comprising at least support beams of essentially the same length fixed at their first end to the front wall of the elevator shaft or to the exterior wall of the building or similar, said beams being fitted to extend in the horizontal direction to the guide rails and being fixed to the guide rails such that the fixing point to the guide rails is situated between the first end and the second end of the support beams at a horizontal distance from the second end.

2. Roping arrangement according to claim 1, wherein-the aforementioned horizontal distance is fitted such that the forces caused by the suspension are distributed as centrally as possible to the guide rails of the elevator car.

3. Roping arrangement according to claim 1, wherein the second ends of the support beams are connected to each other with a substantially rigid support element, to both ends of which a diverting pulley is fixed near the second end of the support beam.

4. Roping arrangement according to claim 1, wherein the diverting pulleys on the elevator car are fixed to the car sling on essentially the upper part of the elevator car.

5. Roping arrangement according to claim 1, wherein the diverting pulleys in the upper part of the elevator shaft are situated substantially symmetrically to each other as viewed from above on different sides of the guide rail line of the guide rails and in that the diverting pulleys on the elevator car are situated on the side walls of the elevator car and substantially symmetrically to each other on different sides of the guide rail line of the guide rails as viewed from above.

6. Roping arrangement according to claim 1, wherein the elevator is provided with a counterweight, and that the ropes are fitted to pass from their first end substantially anchored in the upper part of the shaft at first to the diverting pulley on the counterweight, from where the ropes are disposed to pass via the diverting pulley anchored in the upper part of the elevator shaft back to the diverting pulley on the counterweight, from where the ropes are disposed to pass to the traction sheave of the drive machine anchored in the upper part of the elevator shaft, from which traction sheave the hoisting ropes are disposed to pass onwards to at least one diverting pulley on the elevator car, after passing around which the hoisting ropes are disposed to pass via at least two diverting pulleys in the upper part of the elevator shaft to a second diverting pulley on the elevator car, after passing around which the hoisting ropes are disposed to continue to an anchored fixing point in the upper part of the elevator shaft, to which the second end of the hoisting ropes is fixed.
